(19) United States
(12) Patent Application Publication
(10) Pub. No.: US 2025/0250994 A1
(43) Pub. Date: Aug. 7, 2025

(54) CEILING FAN WITH FILTER FUNCTION

(71) Applicant: Shunde Yongyi Mountainair Electric & Lighting Appliance Co., Ltd., Foshan (CN)

(72) Inventor: WEIDONG GUO, Foshan (CN)

(21) Appl. No.: 18/806,174

(22) Filed: Aug. 15, 2024

(30) Foreign Application Priority Data
Feb. 2, 2024 (CN) 202410146020.3

(51) Int. Cl. F04D 29/70; F04D 19/00; F21V 33/00

(52) U.S. Cl. CPC F04D 29/703; F04D 19/002; F21V 33/0096

(57) ABSTRACT

The present invention relates to a ceiling fan with filter function, wherein the ceiling fan includes a drive motor with blowing blade, to which motor shaft a suspension rod is connected, and a filter, a filter rack, and filter blade with rotational power; the filter is directly or indirectly connected to the drive motor through the filter rack, and the filter, filter blade, and blowing blade are arranged in sequence from top to bottom, and the air pushed by the filter blade has the same direction as the air pushed by blowing blade. The effect of the present invention is to achieve air filtration and circulation while maintaining downward blowing.

### CROSS-REFERENCE TO RELATED APPLICATIONS

This application claims priority to Chinese Patent Application No. 202410146020.3, filed on Feb. 2, 2024, which is hereby incorporated by reference in its entirety.

### TECHNICAL FIELD

The present invention relates to the technical field of ceiling fans and ceiling fan lights, particularly to ceiling fans with filter function.

### BACKGROUND

Traditional ceiling fans include a drive motor with blowing blade, and the motor shaft of drive motor is connected to a suspension rod, and the drive motor is powered to drive blowing blade to rotate and blow downwards.

However, no ceiling fans that can achieve air filtration and circulation are currently available on the market.

### SUMMARY

One purpose of the present invention is to address or alleviate the above-mentioned technical problems.

The method adopted by the present invention is a ceiling fan with filter function, wherein the ceiling fan includes a drive motor with blowing blade, to which motor shaft a suspension rod is connected, and a filter, a filter rack, and filter blade with rotational power; the filter is directly or indirectly connected to the drive motor through the filter rack, and the filter, filter blade, and blowing blade are arranged in sequence from top to bottom, and the air pushed by the filter blade has the same direction as the air pushed by blowing blade.

The effect of the present invention is to achieve air filtration and circulation while maintaining downward blowing.

In a further technical solution, the filter blade are fixedly connected to the drive motor, simplifying the structure and reducing costs.

In a further technical solution, the filter rack is fixedly connected to the suspension rod which passes through the filter rack, and the filter rack is provided with a filter slot and a filter vent hole, and the filter is embedded in the filter slot for easy filter installation and disassembly.

In a further technical solution, the filter holder is box shaped with an inner cavity, and the filter slot is set at the top of filter rack; filter blade are located inside the cavity of filter rack, and there is an overlap between the drive motor and the inner cavity of filter rack in the height direction, and the suspension rod passes through the top surface of filter rack, simplifying the structure and reducing costs.

In a further technical solution, the filter blade is fixed at the top of the drive motor, and the area of filter slot is smaller than that of the bottom opening of filter rack, thus generating a large negative pressure to allow air to pass through the filter and improving the filtering effect.

The further technical solution also includes a motor cover that surrounds the side wall of drive motor; when viewed from above, the inner cavity of filter rack is completely located inside the root of blowing blade, and exhaust gaps are provided in the height direction between the filter rack and motor cover. The solution can not only improve the heat dissipation effect of drive motor, but also enhance the air dispersion.

In a further technical solution, the filter has flexibility and is provided with a central hole and a through gap, and the through gap allows the central hole to communicate with the outside, ensuring filtering effectiveness while facilitating the disassembly and installation of filter.

In a further technical solution, the filter, when viewed from above, is circular in shape.

In a further technical solution, the filter includes one or more of coconut carbon fiber, filter cotton, and activated carbon, and especially the filters made of coconut carbon fiber play an active role in air purification, environmental protection, and health care.

In a further technical solution, the drive motor is connected to a lighting device.

### BRIEF DESCRIPTION OF DRAWINGS

FIG. 1 is 3D schematic diagram I of a ceiling fan with filter function according to an embodiment of the present invention.

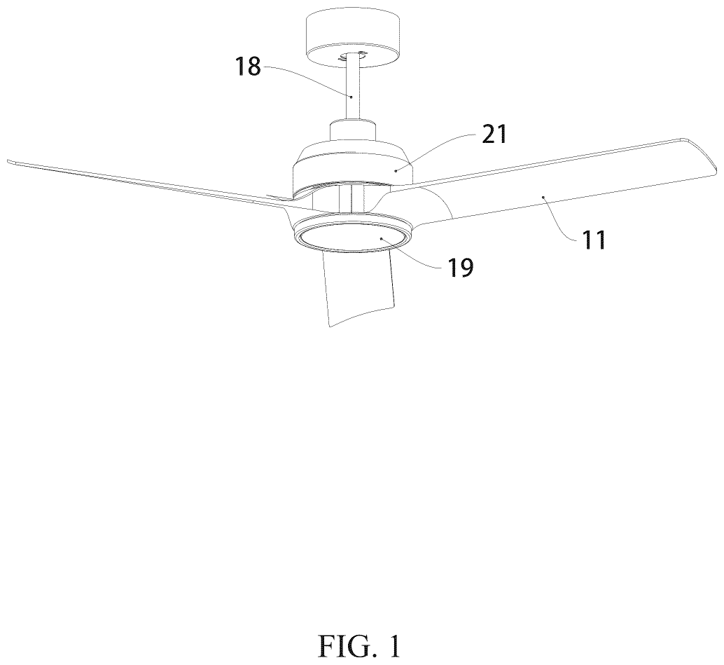

FIG. 2 is a 3D exploded schematic diagram of a ceiling fan with filter function according to an embodiment of the present invention; suspension rod 18 and blowing blade 11 are not shown.

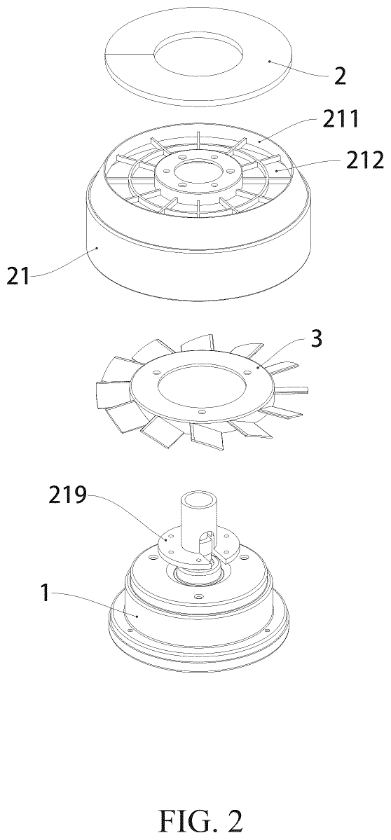

FIG. 3 is a semi sectional schematic diagram of a ceiling fan with filter function according to an embodiment of the present invention; Line 1 represents passing through.

FIG. 4 is a 3D schematic diagram of a ceiling fan with a filter function according to an embodiment of the present invention, with the filter rack 21 partially split open; ARR1 indicates the rotation direction of blowing blade 11 driven by the drive motor 1; ARR2 indicates the rotation direction of filter blade 3; ARR3 indicates the approximate direction in which air passes through filter 2; ARR4 indicates the approximate direction in which air is discharged after being filtered by filter 2.

FIG. 5 is schematic diagram II of a ceiling fan with filter function according to an embodiment of the present invention; the dashed line represents the expanded state of through gap 291 of filter 2; ARR5 indicates the direction in which the filter 2 is moved to allow the suspension rod 18 to pass through the through gap 291; ARR6 indicates the direction in which filter 2 is moved downward to fit into filter slot 211.

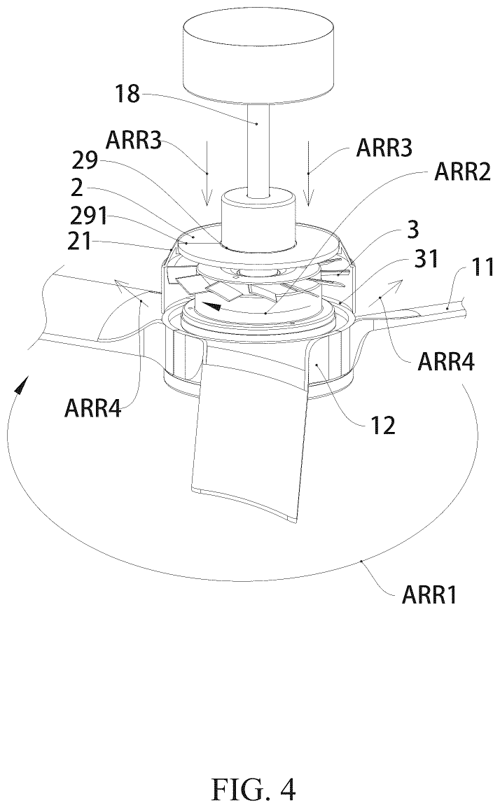

Among the drawings of the specification, FIG. 4 is designated as the abstract drawing.
LINE1; ARR1; ARR2; AARR3; ARR4; ARR5; ARR6; Drive motor 1; blowing blade 11; Motor cover 12; Suspension rod 18; Lighting device 19; Filter 2; Filter rack 21; Filter slot 211; Filter vent hole 212; Connector 219; Center hole 29; Through gap 291; Filter blade 3; Exhaust gap 31.

### DETAILED DESCRIPTION OF THE EMBODIMENTS

The specific embodiments of the present invention will be described below with reference to the accompanying drawings of the specification.

As a specific embodiment, the ceiling fan with filter function in the present invention includes a drive motor 1 with blowing blade 11, the motor shaft of drive motor 1 (not marked in the attached figure) is connected to a suspension rod 18 and, it is easy to understand that the suspension rod 18 can be understood as a part of the drive motor 1. As shown in FIG. 4, the suspension rod 18 is used to suspend the drive motor 1 on the top wall of the room, etc., the drive motor 1 drives blowing blade 11 to rotate and blow downwards; the top of suspension rod 18 is usually provided with hanging tools (not marked in the attached figure) for decoration and other functions.

The ceiling fan with filter function in the embodiments of the present invention further includes a filter 2, a filter rack 21, and filter blade 3 with rotational power; filter blade 3 can have rotational power driven by other motors, or have rotational power through the drive modes described later.

The filter 2 is directly or indirectly connected to the drive motor 1 through the filter rack 21.

The filter 2, filter blade 3, and blowing blade 11 are arranged in sequence from top to bottom;

The air pushed by filter blade 3 has the same direction as the air pushed by the blowing blade 11 and, it is easy to understand that the air pushed by filter blade 3 is also downward.

The working principle is that while the drive motor 1 is started to achieve downward blowing, the filter blade 3 rotates to make the air flow downward and pass through the filter 2; and after passing through filter 2, the air is filtered to form filtered air; the filtered air is then transported, dispersed, and circulated downwards through the blowing blade 11; in other words, the solution can achieve air filtration and circulation while maintaining downward airflow.

As one of the specific embodiments, filter blade 3 is fixedly connected to drive motor 1 and, it is easy to understand that drive motor 1 enables filter blade 3 to have rotational power and accordingly, the blowing blade 11 has the same inclination direction as the filter blade 3, so that the air pushed by both has the same direction. Dispense with additional motors, the solution can simplify the electronic control parts such as circuit boards accordingly, thus providing a simplified structure with reduced costs.

As one of the specific embodiments, the filter rack 21 is fixedly connected to the suspension rod 18, for example, it is fixed by screws to the connecting piece 219 fixed on the suspension rod 18, the suspension rod 18 passes through filter rack 21, and the filter rack 21 is provided with a filter slot 211 and a filter vent hole 212, and the filter element 2 is embedded in the filter slot 211. The filter rack 21, for example, is generally disc-shaped or as described in the following embodiments, facilitating the installation and removal of filter 2.

As one of the specific embodiments, the filter rack 21 is box shaped and has an inner cavity, and the filter slot 211 is set at the top of the filter rack 21; the filter blade 3 is located inside the inner cavity of the filter rack 21, and there is an overlap in the height direction between the drive motor 1 and the inner cavity of filter rack 21, and the suspension rod 18 passes through the top surface of filter rack 21. Dispense with dustproof device for the drive motor, the solution can simplify the structure and reduce the costs.

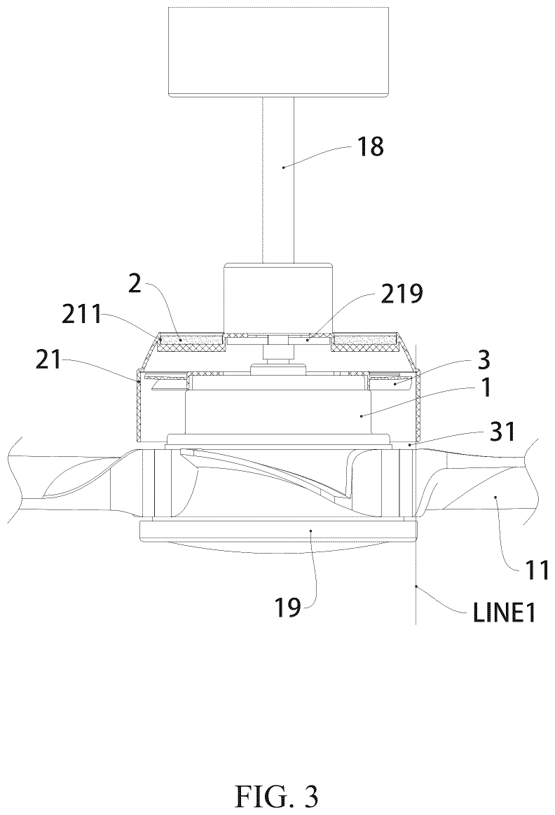

As one of the specific embodiments, the filter blade 3 is fixed at the top of the drive motor 1, and the area of the filter slot 211 is smaller than the area of the bottom opening of the filter rack 21. As shown in FIG. 3, the top of the filter rack 21 is a conical shape with a small top and a large bottom, therefore the filter slot 211 has a smaller area of than the bottom opening of filter rack 21, and the filter blade 3 rotates to generate a large negative pressure to allow air to pass through the filter and improve the filtering effect.

As one of the specific embodiments, the ceiling fan in an embodiment of present invention further includes a motor cover 12 that surrounds the side wall of drive motor 1; the root of blowing blade 11 is the part having an inclination angle from the inside out (i.e., the direction away from the axis of drive motor 1). As shown in FIG. 4, the filtered air passes through the drive motor 1 to dissipate heat, and is discharged from the exhaust gap 31 in a horizontal vector direction. Therefore, the filtered air discharged from the exhaust gap 31 is more easily dispersed by the blowing blade 11, thus improving air dispersion while dissipating heat from the drive motor 1.

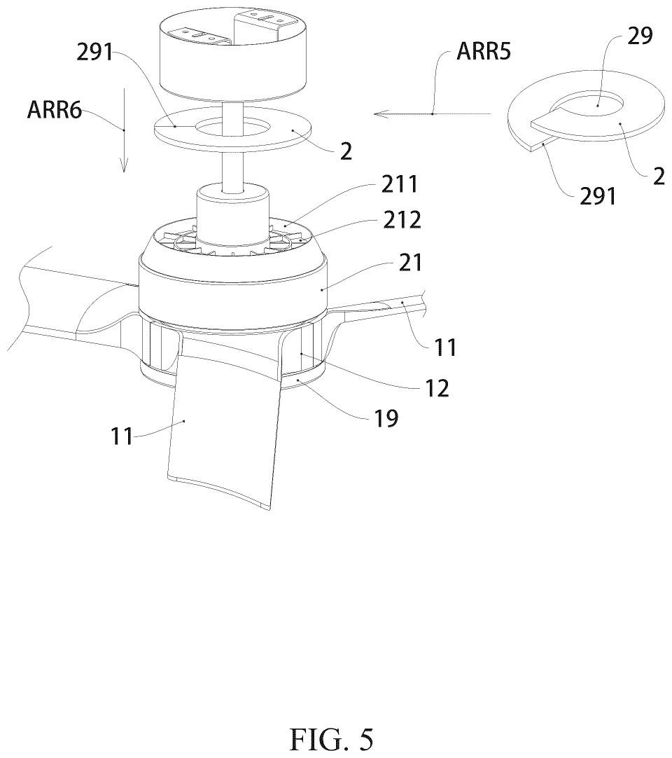

As one of the specific embodiments, the filter 2 has flexibility and is provided with a central hole 29 and a through gap 291; the through gap 291 allows the central hole 29 to communicate with the outside. It is easy to understand that the connection with the outside refers to the case in which an object can enter the central hole 29 through the through gap 291. The filter 2, which is a type of consumables, can be optionally replaced after 3 to 4 months of use. As shown in FIG. 5, to replacing filter 2, bend it to enlarge the through gap 291. The suspension rod 18 can pass through the enlarged through gap 291, and then insert filter 2 into the filter slot 211 to complete the installation of filter. At this time, the filtering flux area of filter 2 is restored to its maximum to ensure the filtering effect; On the contrary, the filter element 2 can be disassembled. ensuring the filtering effect while facilitating the disassembly and installation of filter element

As one of the specific embodiments, the filter 2, when viewed from above, is circular in shape, and so is the filter slot 211 when viewed from above.

As one of the specific embodiments, the filter 2 includes one or more of coconut carbon fiber, filter cotton, and activated carbon, and especially the filters 2 made of coconut carbon fiber play an active role in air purification, environmental protection, and health care.

As one of the specific embodiments, the drive motor 1 is connected to a lighting device 19. The lighting device 19 is a conventional device capable of emitting light, typically including LED emitters and lampshades. The lighting device 19 is usually installed at the bottom of the drive motor 1.

The terms used in the present invention, such as first, second, etc., do not indicate any order, quantity, or importance, but are only used for distinction.

The terms used in the present invention, such as one, a, etc. do not indicate a limitation in quantity, but rather the existence of at least one object mentioned.

In the present invention, the terms indicating orientation or position, such as top, bottom, side, longitudinal, transverse, middle, center, outer, inner, horizontal, vertical, left, right, upper, lower, etc., mean to reflect relative position rather than absolute position.

The terms used in the present invention, such as general, overall, approximate, similar, etc., are intended to indicate limiting terms that have features but allow for certain deviations. The amount of allowable deviation may vary, depending on the specific background, for example, the deviation in size may depend on specific backgrounds, including but not limited to relevant standards for size tolerance.

1. A ceiling fan with filter function, including a drive motor with blowing blade, and a suspension rod connected to a motor shaft of the drive motor; further including a filter, a filter rack, and a filter blade with rotational power;
the filter is connected to the drive motor through the filter rack;
the filter, filter blade, and blowing blade are arranged in sequence from top to bottom;
air pushed by the filter blade has the same direction as the air pushed by the blowing blade;
the filter rack is provided with a filter slot and a filter vent hole,
wherein an area of the filter slot is smaller than that of a bottom opening of the filter rack;
the blowing blade has the same inclination direction as the filter blade.

2. The ceiling fan with filter function according to claim 1, wherein the filter blade are is fixedly connected to the drive motor.

3. The ceiling fan with filter function according to claim 1, wherein the filter rack is fixedly connected to the suspension rod that passes through the filter rack, the filter is embedded in the filter slot.

4. The ceiling fan with filter function according to claim 3, wherein the filter rack has an inner cavity, and the filter slot is set at a top of the filter rack;
the filter blade is located inside the inner cavity, and there is an overlap in a height direction between the drive motor and the inner cavity of the filter rack, and the suspension rod passes through a top surface of the filter rack.

5. The ceiling fan with filter function according to claim 4, wherein the filter blade is fixed at a top of the drive motor.

6. The ceiling fan with filter function according to claim 4, further including a motor cover that surrounds a side wall of the drive motor; when viewed from above, the filter rack is located radially interior of a root of the blowing blade, and exhaust gaps are provided in the height direction between the filter rack and the motor cover.

7. The ceiling fan with filter function according to claim 3, wherein the filter has flexibility and is provided with a central hole and a through gap; the through gap allows the central hole to communicate with an outside.

8. The ceiling fan with filter function according to claim 3, wherein the filter, when viewed from above, is circular in shape.

9. The ceiling fan with filter function according to claim 6 wherein the filter includes one or more of coconut carbon fiber, filter cotton, and activated carbon.

10. The ceiling fan with filter function according to claim 6, wherein the drive motor is connected to a lighting device.
